(19) United States
(12) Patent Application Publication
(10) Pub. No.: US 2005/0056483 A1
(43) Pub. Date: Mar. 17, 2005

(54) Tail pipe for muffler

(76) Inventor: Hsi-Lung Tsai, Changhua Hsien (TW)

Correspondence Address: Cooper & Dunham LLP, 1185 Avenue of the Americas, New York, NY, 10036, US

(21) Appl. No.: 10/662,905

(22) Filed: Sep. 15, 2003

(51) Int. Cl. B64F 1/26; F01N 7/08

(52) U.S. Cl. 181/227; 181/228; 181/217

(57) ABSTRACT

A tail pipe includes a body, two internal fittings and an optional illuminating assembly. The body has an inner passage and two windows defined through the body. Each internal fitting is mounted in the inner passage of the body, and corresponds to one of the windows, and has a side face that faces the window and a protrusion formed from the side face. The protrusions are received in the windows and extend partially out of the window. The illuminating assembly is mounted in the inner passage of the body and has multiple illuminating members to light the internal fittings to be visible in a dark place. Therefore, the internal fittings will provide a decoration for the tail pipe to make that look more attractive and also provide a visible signal to alert someone who is adjacent to the tail pipe to the danger of being burned.

### BACKGROUND OF THE INVENTION

1. Field of the Invention

The present invention relates to a tail pipe for a muffler, and more particularly to a tail pipe having internal fittings that make the tail pipe look more attractive and perform warning signs.

2. Description of Related Art

Vehicle tail pipes in accordance with the prior art do not have any feature for visible warning or decoration and so the existing tail pipes are potentially hazardous and not attractive. Besides, special accessories for a vehicle are popular with some drivers who enjoy customizing and thus distinguishing their vehicles from others. Especially, when a vehicle uses a luminous tail pipe in a dark environment, the vehicle will attract the attention of surrounding people. Such aforesaid features to a tail pipe have not appeared in the market yet.

Because combusted gas in an engine of a vehicle is exhausted through the mufflers and the exhaust pipes of the mufflers, the temperature of exhaust pipes of mufflers is so high that somebody who touches inadvertently the exhaust pipes will be burned. This is especially true for a vehicle that has recently become stationary and a passerby may not realize that in fact the exhaust pipe and surrounding elements are still very hot. The tail pipes are attached to the exhaust pipes of the mufflers to prevent the hot exhaust pipes from burning somebody. However, the temperature of the tail pipes will simultaneously rise due to radiated heat from the hot exhaust pipe. Visible warning signs for the tail pipes are required to indicate the danger.

To overcome the shortcomings, the present invention provides an improved tail pipe having internal fittings to mitigate or obviate the aforementioned problems.

### SUMMARY OF THE INVENTION

The main objective of the invention is to provide an improved tail pipe for a muffler wherein the tail pipe has internal fittings that provides a decoration for the tail pipe.

Another objective of the invention is to provide an improved tail pipe for a muffler wherein the tail pipe is luminous to provide functions of warning.

To achieve the aforementioned objective, a tail pipe in accordance with the present invention comprises a hollow body, two internal fittings and an optional illuminating assembly. The hollow body has an inner passage that has a front opening, a rear opening and two windows. The windows are located opposite to each other and each of them has a given shape. Each internal fitting is mounted in the inner passage of the body by means of fasteners and corresponds to one of the windows. The internal fitting has a side face that faces the window and a protrusion formed from the side face. The protrusion has a shape that corresponds to the shape of the window, is received in the window and extends partially out of the window.

The illuminating assembly is mounted in the inner passage of the body to illuminate the internal fittings to be visible in a dark place. The internal fittings are made of transparent or translucent materials. Therefore, the internal fittings will provide a visible signal to show a position of the tail pipe and function as a warning signal to alert someone who is close to the tail pipe to keep a distance from the hot tail pipe.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tail pipe for a muffler in accordance with the present invention;

FIG. 2 is an exploded perspective view of the tail pipe in FIG. 1 that further has an illuminating assembly;

FIG. 3 is a perspective view of the tail pipe in FIG. 1;

FIG. 4 is an operational perspective view of the tail pipe in FIG. 1; and

FIG. 5 is an operational perspective view of an alternative embodiment of the tail pipe in FIG. 2.

### DETAILED DESCRIPTION OF PREFERRED EMBODIMENT

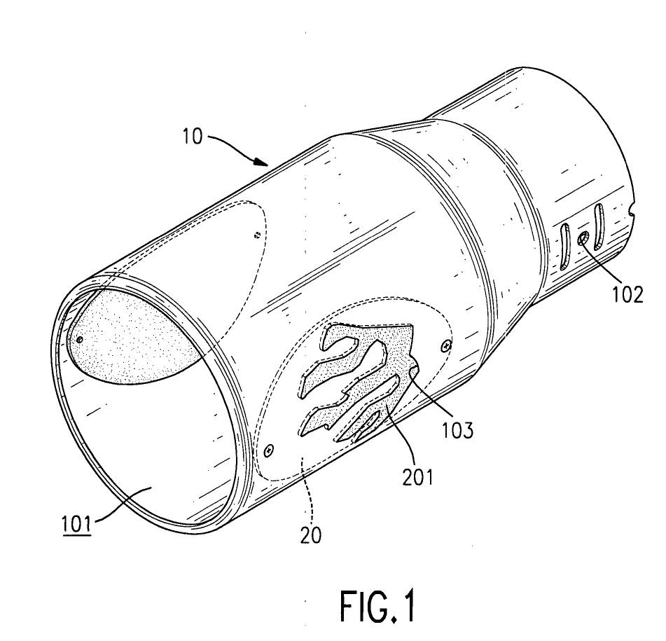

With reference to FIG. 1, a tail pipe in accordance with the present invention comprises a hollow body (10) and two internal fittings (20). The hollow body (10) has a front (not numbered), a rear (not numbered), an outer periphery (not numbered) and an inner passage (101). The inner passage (101) has an inner periphery (not numbered), a front opening (not numbered) and a rear opening (not numbered) that are defined respectively in the front and the rear of the body (10).

With reference to FIGS. 1, 2 and 4, the body (10) further has two mounting holes (102) and two windows (103) defined through the outer periphery. The windows (103) are located opposite to each other and each of them has a given shape (not numbered). The mounting holes (102) are defined in the outer periphery near the rear of the body (10) whereby the tail pipe can be fixed to an exhaust pipe (31) of a muffler (not shown) by means of fasteners, such as screws (30). Each internal fitting (20) is mounted on the inner periphery of the body by means of fasteners, such as screws (30) and corresponds to one of the windows (103). The internal fitting (20) has a side face (not numbered) that faces the window (103) and a protrusion (201) formed from the side face. The protrusion (201) has a shape that corresponds to the shape of the window (103), is received in the window (103) and extends partially out of the window (103).

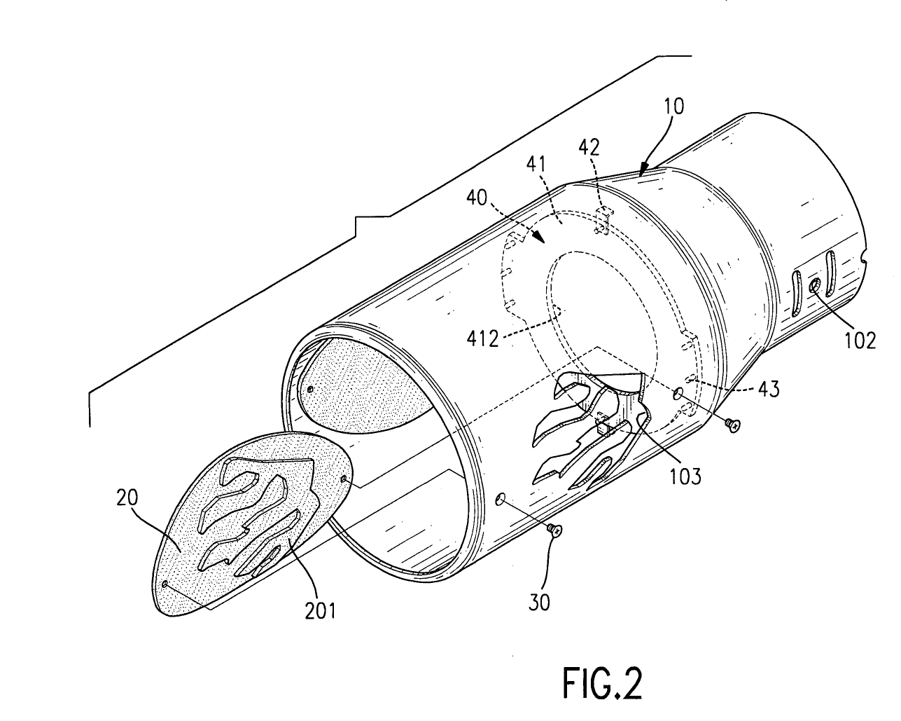

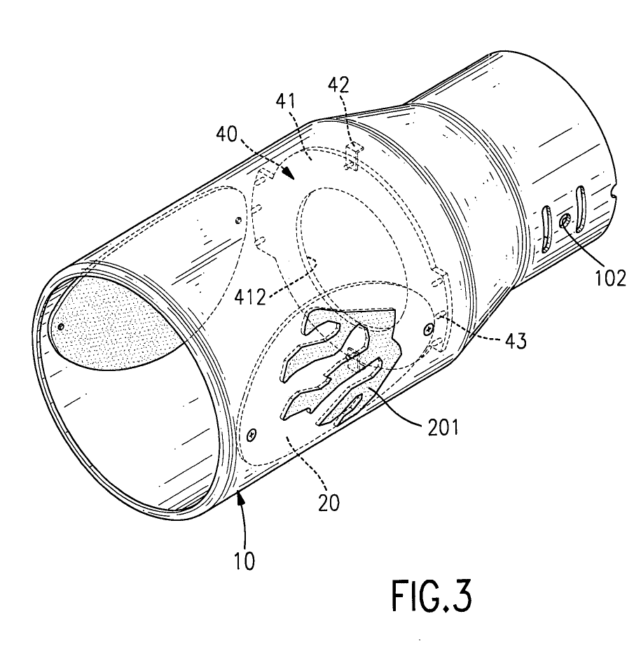

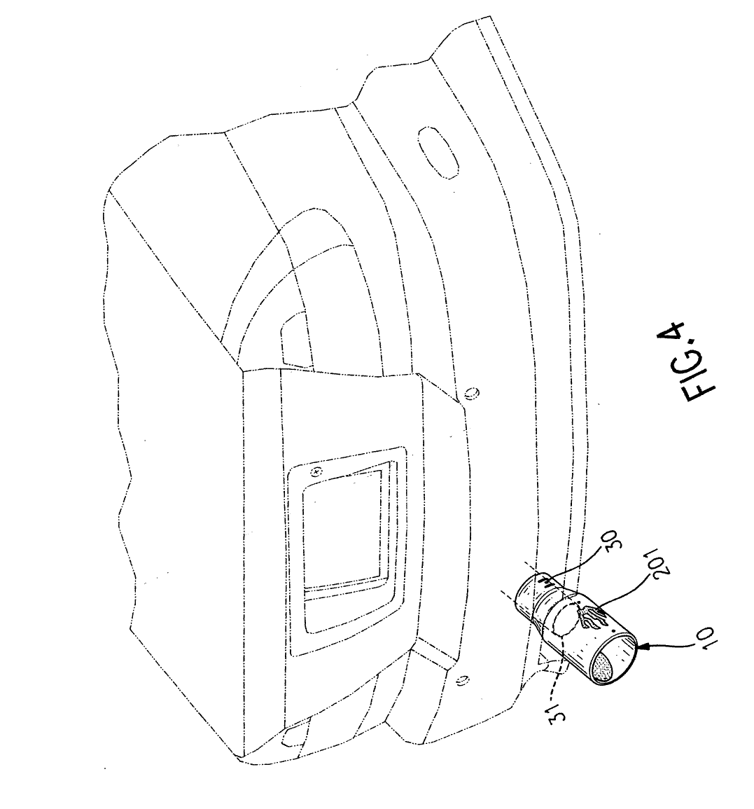

With reference to FIGS. 2 and 3, the tail pipe further comprises a illuminating assembly (40) to light the internal fittings (20) while the internal fittings (20) are made of transparent or translucent materials. The illuminating assembly (40) comprises a circuit board (41), two mounting brackets (42) and multiple illuminating members (43), such as-light emitting diodes (LEDs). The mounting brackets (42) are respectively attached to the inner periphery of the body (10) and are L-shaped. The circuit board (41), which connects electrically to the electricity supply of a vehicle, is mounted on the mounting brackets (42) and is ring-shaped with a central through hole (412) that allows the exhaust pipe (31) in FIG. 4 to extend thereinto. The illuminating members (43) connect electrically to the circuit board (41) so the illuminating members (43) can be lit for performing warning signs after the vehicle becomes recently stationary to prevent people walking around the parked vehicle form getting burned. Also, the illuminating members (43) can be illuminated for decoration of the vehicle while the vehicle is moving in a dark environment. The illuminating members (43) face a respective one of the internal fittings (20) and produce light that is transmitted to the internal fittings (20) to make the internal fittings (20) visible in a dark environment.

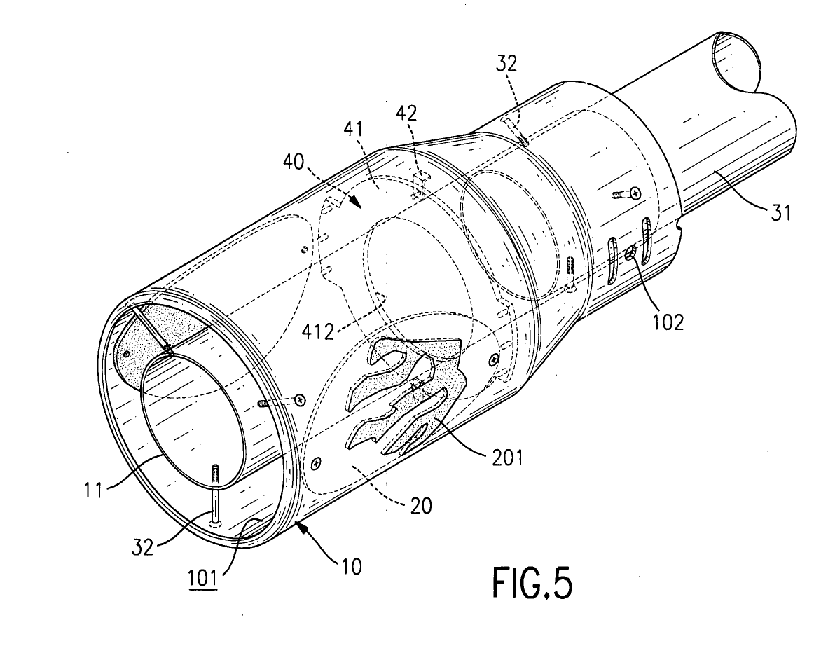

With reference to FIG. 5, the aforesaid tail pipe further has an inner pipe (11) mounted in the inner passage (101) of the body (10). The inner pipe (11) has a front opening (not numbered) and a rear opening (not numbered) that extend respectively toward the front and the rear openings of the inner passage (101). The inner pipe (11) extends through and is held in the central through hole (412) of the circuit board (40) and is suspended by fasteners, such as bolts (32) or rivets (not shown). The rear opening of the inner pipe (11) connects to the exhaust pipe (31) to guide the combusted gas being directly exhausted through the inner pipe (11) to prevent the illuminated assembly (40) from being contaminated by the combusted gas.

Therefore, the protrusion (201) of the internal fittings (20) can be formed as a decorative pattern to make the tail pipe to look more attractive. Especially in a dark place, the illuminating internal fittings (20) will provide an unexpected yet eye-catching decoration effect for the tail pipe.

Besides, the internal fittings (20) will provide a visible signal to show an exact position of the tail pipe regarded as a warning signal to alert someone who is adjacent to the tail pipe to keep a distance away from the tail pipe to avoid being burned.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A tail pipe for a muffler having an exhaust pipe and comprising:
a hollow body having a front, a rear, an outer periphery, at least one window defined through the outer periphery and an inner passage with an inner periphery, the inner passage having a front opening and a rear opening that are formed respectively in the front and the rear of the body, and each of the at least one window having a shape; and
an internal fitting corresponding to each respective one of the at least one window mounted on the inner periphery in the body, and each internal fitting having a side face that faces the corresponding window and a protrusion formed from the side face, the protrusion having a shape that corresponds to the shape of the corresponding window, being received in the corresponding window and extending partially out of the corresponding window.

2. The tail pipe for the muffler as claimed in claim 1, wherein each internal fitting is light transmittable and the tail pipe further comprising an illuminating assembly to light each internal fitting, and the illuminating assembly comprises
multiple mounting brackets respectively attached to the inner periphery in the body;
a circuit board mounted on the mounting brackets; and
multiple illuminating members connecting electrically to the circuit board and respectively facing the at least one internal fitting to make each internal fitting visible in a dark environment.

3. The tail pipe for the muffler as claimed in claim 2, wherein the illuminating members are light emitting diodes.

4. The tail pipe for the muffler as claimed in claim 3, wherein the mounting brackets are L-shaped, and the circuit board has a ring-shape with a central through hole.

5. The tail pipe for the muffler as claimed in claim 4, wherein the body further has two mounting holes defined through the outer periphery to mount the tail pipe on the exhaust pipe of the muffler with fasteners.

6. The tail pipe for the muffler as claimed in claim 5 further comprising an inner pipe mounted in the inner passage of the body, having a front opening and a rear opening and held in the central through hole of the circuit board, and suspended by means of fasteners, and the rear opening of the inner pipe connecting to the exhaust pipe.
